(19) United States
(12) Patent Application Publication
(10) Pub. No.: US 2015/0088359 A1
(43) Pub. Date: Mar. 26, 2015

(54) MOBILE ROBOT WITH RETURNING MECHANISM

(71) Applicant: Electronics and Telecommunications Research Institute, Daejeon (KR)

(72) Inventors: Sunglok CHOI, Daejeon (KR); Woo han Yun, Daejeon (KR); Jae Hyun Park, Daejeon (KR); SeungHwan Park, Daejeon (KR); Wonpil Yu, Daejeon (KR); Yu-Cheol Lee, Daejeon (KR)

(73) Assignee: Electronics and Telecommunications Research Institute, Daejeon (KR)

(21) Appl. No.: 14/193,315

(22) Filed: Feb. 28, 2014

(30) Foreign Application Priority Data
Sep. 26, 2013 (KR) 10-2013-0114335

(51) Int. Cl. G05D 1/02

(52) U.S. Cl. CPC G05D 1/0225; Y10S 901/01
USPC 701/23; 901/1

(57) ABSTRACT

A mobile robot having a returning mechanism includes one or more moving members mounted on a body of the mobile robot; and a cable member connected to one side of the mobile robot so as to supply the mobile robot with electrical power. Further, the mobile robot includes a returning member having a rigidity stronger than the cable member and disposed to wrap the cable member so that the cable member is placed within the returning member; and a take-up unit configured to pull the returning member to keep it taut.

### CROSS-REFERENCE TO RELATED APPLICATION(S)

The present invention claims priority of Korean Patent Application No. 10-2013-0114335, filed on Sep. 26, 2013, which is incorporated herein by reference.

### FIELD OF THE INVENTION

The present invention relates to a mobile robot having a returning mechanism, and more specifically, to a method and apparatus for returning a mobile robot to an initial location from a hazardous area at a situation where the mobile robot cannot be remotely controlled.

### BACKGROUND OF THE INVENTION

In recent years, there has been proposed a method to deploy a mobile robot in an area where people do not access directly because of a lot of hazardous factors such as radioactive area and remotely control the mobile robot to accomplish the intended task.

After that, a method of returning the mobile robot to an origin point is performed by a method using image information. In connection with the method of returning a moving body, a prior art of Korean Patent Registration No. 10-0645814, which is registered on Nov. 23, 2006, discloses a method to control the moving body to return to the origin point by using the infrared image information of an infrared module inputted from a camera module.

However, in the provision of the method to return the mobile robot, the aforementioned prior art does not disclose how to return a mobile robot to an initial starting point when the communication between a moving body and a remote control device is disconnected. Further, the prior art is silent to disclose any configuration in which the mobile robot is controlled to independently move in the direction of the initial starting location when it is located in the hazardous area but personnel cannot access the hazardous area.

### SUMMARY OF THE INVENTION

In view of the above, the present invention provides a mobile robot having a returning mechanism that includes a returning member having a rigidity stronger than a cable member of the mobile robot and one or more moving members and that is capable of returning the mobile robot to an original location by using the returning member and tension thereof even when the mobile robot falls in a deadlock. However, the technical subjects of the embodiment of the present invention are not limited to the aforementioned subjects, and there may be other technical subjects.

In accordance with an embodiment of the present invention, there is provided a mobile robot having a returning mechanism. The mobile robot includes one or more moving members mounted on a body of the mobile robot; a cable member connected to one side of the mobile robot so as to supply the mobile robot with electrical power; a returning member having a rigidity stronger than the cable member and disposed to wrap the cable member so that the cable member is placed within the returning member; and a take-up unit configured to pull the returning member to keep it taut.

In accordance with any one of solutions to the subject described above, it is possible to implement a method to return the mobile robot by use of the tension of the returning member even if the mobile robot is placed in a situation where it cannot be controlled, thereby prevent safety accidents in advance since personnel need not to put in the hazardous area.

### BRIEF DESCRIPTION OF THE DRAWINGS

The above and other objects and features of the present invention will become apparent from the following description of the embodiments given in conjunction with the accompanying drawings, in which:

FIG. 1 shows a perspective view of a mobile robot having a returning mechanism in accordance with an embodiment of the present invention;

FIG. 2 is a sectional view of a returning member and cable member of a mobile robot having a returning mechanism shown in FIG. 1;

FIGS. 3A and 3B show perspective views of a mobile robot having a returning mechanism in accordance with a first embodiment of the present invention;

FIG. 4 is a side view of a mobile robot having a returning mechanism in accordance with a second embodiment of the present invention;

FIGS. 5A and 5B show a mobile robot having a returning mechanism in accordance with a third embodiment of the present invention, wherein FIG. 5A is a side view of a mobile robot having a returning mechanism and FIG. 5B illustrates a state where the mobile robot is enveloped by the returning collection mechanism;

FIGS. 6A and 6B are side views of a mobile robot having a returning mechanism in accordance with a fourth embodiment of the present invention; and

FIGS. 7A and 7B show perspective views of a mobile robot having a returning mechanism in accordance with a fifth embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

Throughout the specification and the claims, when an element is described as being “connected” to another element, this implies that the elements may be directly connected together or the elements may be connected through one or more intervening elements. Furthermore, when an element is described as “including” one or more elements, this does not exclude additional, unspecified elements, nor does it preclude the presence or addition of one or more other features, integers, steps, operations, elements, components and/or groups thereof.

Hereinafter, the embodiments of the present invention will be described in detail with reference to the accompanying drawings.

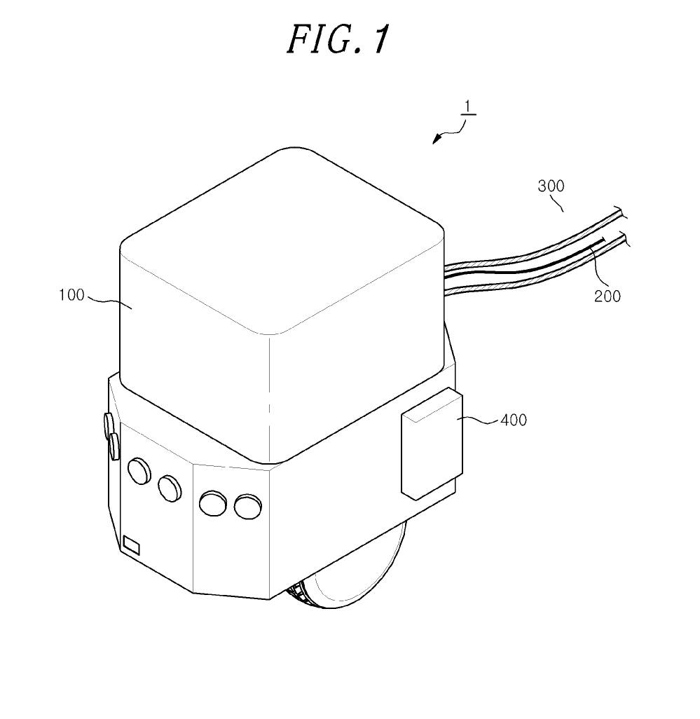

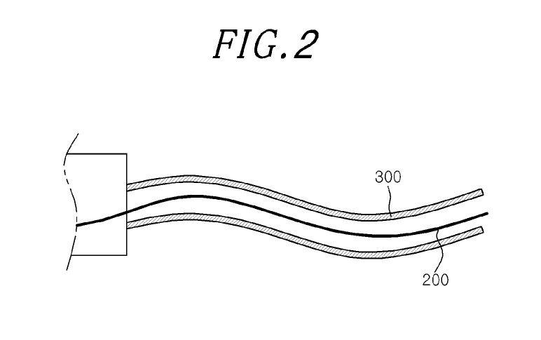

FIG. 1 shows a perspective view of a mobile robot having a returning mechanism in accordance with an embodiment of the present invention, and FIG. 2 is a sectional view of a returning member and a cable member of the mobile robot having a returning mechanism shown in FIG. 1.

A mobile robot having a returning mechanism in accordance with an embodiment of the present invention includes one or more moving members 100, a cable member 200, a returning member 300, and a take-up unit 400. However, the mobile robot having a returning mechanism is merely an example and the present invention is therefore not construed to be limited to that illustrated in FIG. 1.

The one or more moving members 100 are mounted on a body of the mobile robot 1 having a returning mechanism. The moving member 100 may be modified depending on various embodiments of the present invention, which will be discussed later. Herein, the mobile robot 1 having a returning mechanism and the mobile robot 1 are defined to indicate the identical entity.

The cable member 200 is coupled to one side of the mobile robot 1 so that an electrical power can be supplied to the mobile robot 1.

The returning member 300 has rigidity stronger than the cable member 200 and wraps the cable member 200 to place the cable member 200 within the returning member 300. Referring to FIG. 2, the returning member 300 may be substituted with a fire hose of a fire fighting robot (not shown) or a wired communication cable of a nuclear robot (not shown). That is to say, the fire fighting robot is equipped with a fire hose and the nuclear robot is equipped with a wired communication cable, and these firefighting and nuclear robots may take advantage of the fire hose and the wired communication cable as a returning rope, instead of equipping with a separate returning rope. For that reason, the returning member 300 of the embodiment may also be embodied in the fire hose or the wired communication cable. Accordingly, even if the returning member 300 is severely pulled under high tension, the returning member 300 is able to withstand the pulling tension without being cut off. In this case, the cable member 200 may include a cladding having the rigidity stronger than the cable member 200.

Referring back to FIG. 1, the take-up unit 400 takes care of the returning member 300, e.g., by pulling on the returning member 300 to keep it taut.

The mobile robot 1 having a returning mechanism in accordance with an embodiment of the present invention can be returned by pulling on the returning member 300 in case where it cannot move by itself due to breakdown.

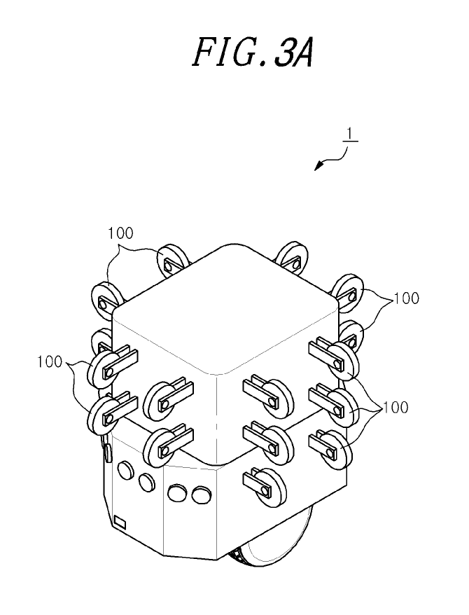

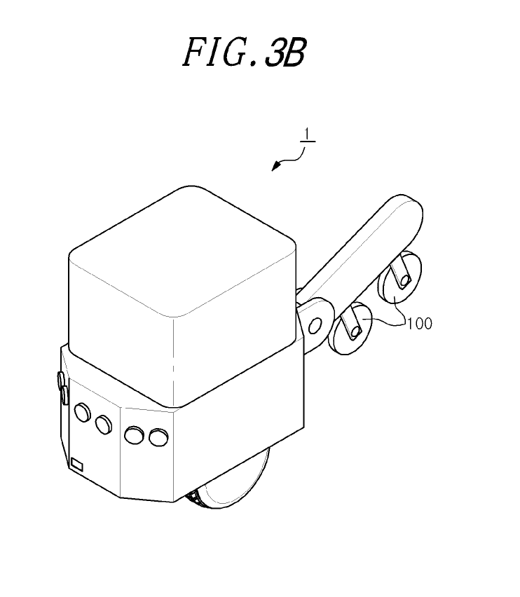

FIGS. 3A and 3B show perspective views of a mobile robot having a returning mechanism in accordance with a first embodiment of the present invention. Referring to FIGS. 3A and 3B, the moving member 100 may be one of ballcasters, wheel-based ballcasters and fixed flippers.

The mobile robot 1 having a returning mechanism in accordance with an embodiment of the present invention can be returned by pulling on the returning member 300 in a situation where it cannot move by itself due to breakdown. However, because the gear ratio between a motor and wheels that are engaged is high, the wheels do not rotate easily once the motor is stopped, which leads to a difficult of returning the mobile robot.

In accordance with a first embodiment of the present invention, therefore, a plurality of the moving members 100 enable to easily move without employing the wheels. For example, although the mobile robot 1 having a returning mechanism falls down on its side, it is possible to return the mobile robot 1 by the roll motion of a plurality of the moving members 100 which are provided on the front and rear sides, and left and right sides of the mobile robot 1 during pulling on the returning member 300.

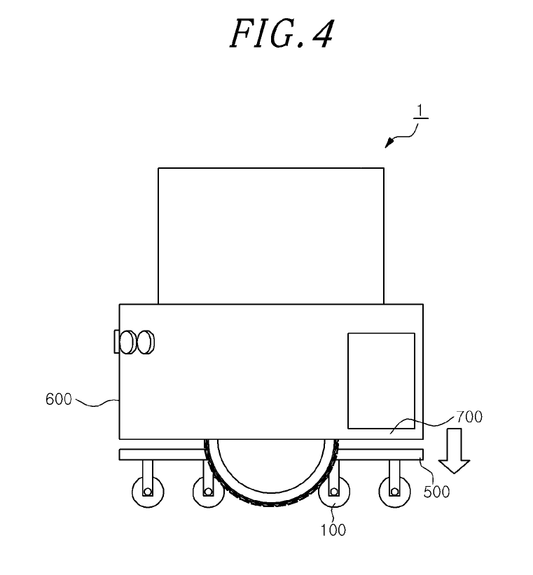

FIG. 4 is a side view of a mobile robot having a returning mechanism in accordance with a second embodiment of the present invention. Referring to FIG. 4, the mobile robot 1 having a returning mechanism of the second embodiment of the present invention further includes a lower panel 500, a control unit 600 and a linear motor 700.

The lower panel 500 is arranged below the mobile robot 1. The moving member 100 is mounted on the bottom of the lower panel 500.

The control unit 600 detects a state that the mobile robot 1 is not able to move, and the linear motor 700 allows the lower panel 500 to descend by pushing the lower panel in a downward direction when the control unit 600 detects a state that the mobile robot 1 is not able to move. Therefore, the moving member 100 is protruded downwardly further than a moving unit of the mobile robot 1 by the linear motor 700 so that it can step on land. Here, the moving unit may be one or more wheels of the mobile robot 1.

With the configuration of the returning mechanism included in the mobile robot 1, it is possible to return the mobile robot 1 having a returning mechanism by protruding the lower panel 500 or lowering the lower panel 500 on which the moving member 100 is mounted on the bottom of the mobile robot 1 and pulling on the returning member 300 when the mobile robot 1 breaks down and is not able to move. In other words, since a rolling motion may not occur when the mobile robot 1 falls in a deadlock during the motor and the wheels are engaged with each other, the mobile member 100 which is capable of rolling is protruded to step on land, whereby the mobile robot 1 can be returned even when it remains stationary.

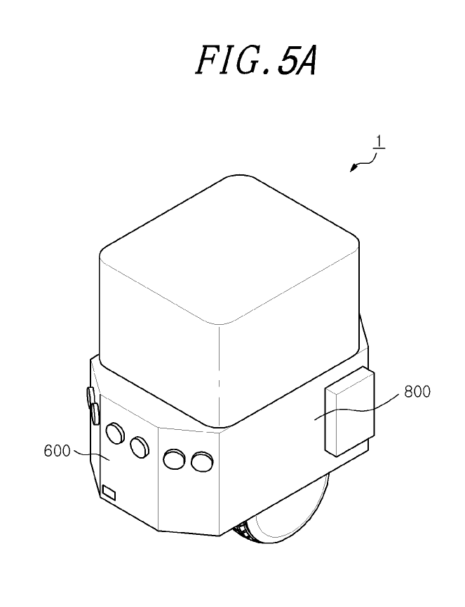

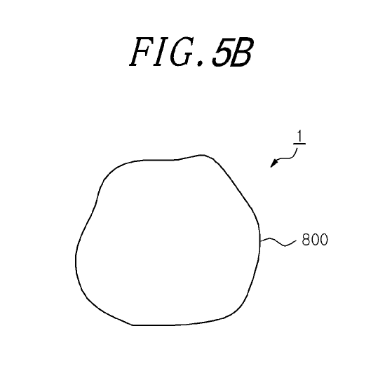

FIGS. 5A and 5B show a mobile robot having a returning mechanism in accordance with a third embodiment of the present invention, wherein FIG. 5A is a side view of a mobile robot having a returning mechanism and FIG. 5B illustrates a state where the mobile robot is enveloped by the returning collection mechanism. Referring to FIGS. 5A and 5B, the mobile robot 1 having a returning mechanism in accordance with a third embodiment of the present invention further includes an airbag module 800 and a control unit 600.

The airbag module 800 is mounted to envelope an entire body of the mobile robot the mobile robot 1, which may be embodied in the moving member 100.

The control unit 600 detects a state that the mobile robot 1 is not able to move. The airbag module 800 envelopes the mobile robot 1 in the form of a sphere when it is activated. The airbag module 800 protects the mobile robot 1 while providing high elasticity and less friction.

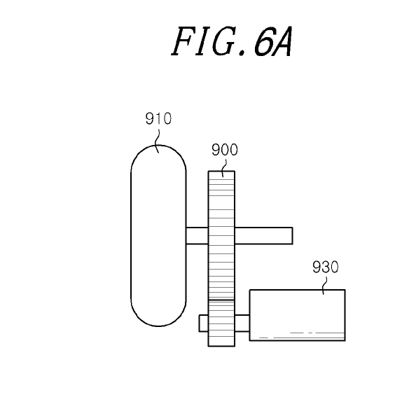

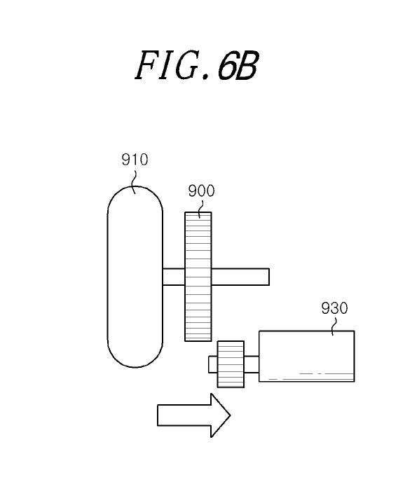

FIGS. 6A and 6B are a side view of a mobile robot having a returning mechanism in accordance with a fourth embodiment of the present invention. Referring to FIG. 1 and FIGS. 6A and 6B, the mobile robot 1 having a returning mechanism further includes one or more gears 900, a primary motor 930 and a control unit 600.

The one or more gears 900 are coupled to a moving unit 910 of the mobile robot 1. The moving unit 910 may be one or more wheels of the mobile robot 1.

The primary motor 930 is engaged with the gear 900 to drive the moving unit 910.

The control unit 600 detects a state that the mobile robot 1 is not able to move. When the control unit 600 detects the state that the mobile robot 1 is not able to move, it forces the primary motor 930 to be separated from the gear 900 by moving the primary motor 930 in one side direction.

The mobile robot 1 having a returning mechanism in accordance with the fourth embodiment of the present invention separates the primary motor 930 from the gear 900 to disconnect between the moving unit 910 and the primary motor 930. As a result, the moving unit 910 which is disconnected with the primary motor 930 can freely roll, thereby returning the mobile robot 1 with the pulling tension of the returning member 300.

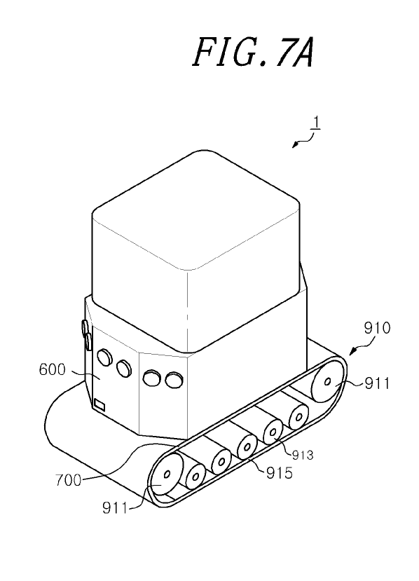

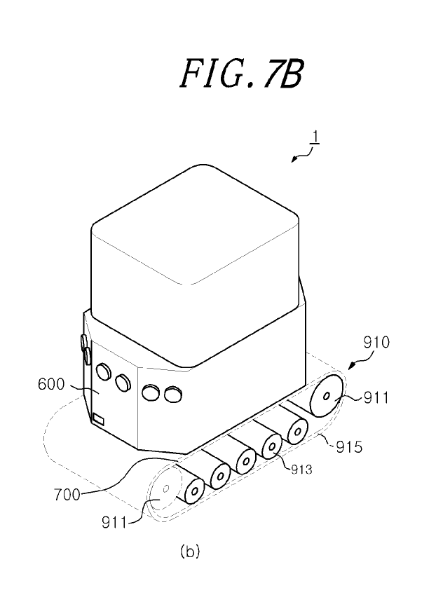

FIGS. 7A and 7B show perspective views of a mobile robot having a returning mechanism in accordance with a fifth embodiment of the present invention. The operation of the mobile robot of FIGS. 7A and 7B will be explained with reference to FIG. 1 as below. The mobile robot 1 having a returning mechanism includes a caterpillar 910 as the moving unit, and further includes a control unit 600 and linear motor 700.

The caterpillar 910 includes one or more main moving rollers 911, an at least subsidiary moving roller 913, and a belt assembly 915 in which a plurality of plates is coupled using pins enclosing the main moving roller 911 and the subsidiary moving roller 913.

The control unit 600 detects a state that the mobile robot 1 is not able to move, and a linear motor 700 is connected with the caterpillar 910. When the control unit 600 detects the state that the mobile robot 1 is not able to move, it drives the linear motor 700 to remove the pins on the belt assembly 915. Or, when the control unit 600 detects the state that the mobile robot 1 is not able to move, it drives the linear motor 700 to remove the main moving roller 911 or the subsidiary moving roller 913.

The mobile robot 1 having a returning mechanism in accordance with a fifth embodiment of the present invention removes the belt assembly 915 of the caterpillar 910 so that the main moving roller 911 cannot contact ground. As a result, the mobile robot 1 can be returned by the roll of the subsidiary moving roller 913 and the pulling tension of the returning member 300.

With the mobile robot 1 having a returning mechanism in accordance with an embodiment of the present invention, when performing fire suppression, mine detection and monitoring and operation of a nuclear facility, even if the mobile robot is not able to move, it is possible to to return the mobile robot without the direct access the hazardous area of the personnel.

Description of the present invention as described above are intended for illustrative purposes, and it will be understood to those having ordinary skill in the art that this invention can be easily modified into other specific forms without changing the technical idea and the essential characteristics of the present invention. Accordingly, it should be understood that the embodiments described above are exemplary in all respects and not limited thereto. For example, respective components described to be one body may be implemented separately from one another, and likewise components described separately from one another may be implemented in an integrated type.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A mobile robot having a returning mechanism, the mobile robot comprising:
one or more moving member mounted on a body of the mobile robot;
a cable member connected to one side of the mobile robot so as to supply the mobile robot with electrical power;
a returning member having a rigidity stronger than the cable member and disposed to wrap the cable member so that the cable member is placed within the returning member; and
a take-up unit configured to pull the returning member to keep it taut.

2. The mobile robot of claim 1, wherein the one or more moving member comprises any one of ballcasters, wheel-based ballcasters and fixed flippers.

3. The mobile robot of claim 1, wherein the one or more moving member is mounted on a lower panel that is disposed at the bottom of mobile robot.

4. The mobile robot of claim 3, further comprising:
a control unit configured to detect a state that the mobile robot is not able to move; and
a linear motor configured to protrude the lower panel downwardly when the control unit detects a state that the mobile robot is not able to move.

5. The mobile robot of claim 4, wherein the one or more moving member is configured to protrude further than the moving unit of the mobile robot by the linear motor.

6. The mobile robot of claim 1, wherein the one or more moving member comprises an airbag module that is mounted to envelope the surface of the mobile robot, further comprising:
a control unit configured to detect a state that the mobile robot is not able to move.

7. The mobile robot of claim 6, wherein the airbag module is activated to envelope the mobile robot in the shape of a sphere when the control unit detects a state that the mobile robot is not able to move.

8. The mobile robot of claim 1, further comprising:
one or more gear that is coupled to a moving unit of the mobile robot;
a primary motor that is engaged with the one or more gear to drive the moving unit; and
a control unit configured to detect a state that the mobile robot is not able to move.

9. The mobile robot of claim 8, wherein the primary motor is configured to be separated from the one or more gear by causing the primary motor to move in one side direction.

10. The mobile robot of claim 1, wherein the moving unit of the mobile robot comprises a caterpillar, the caterpillar comprising:
one or more main moving roller;
one or more subsidiary moving roller; and
a belt assembly configured to enclose the main moving roller and the subsidiary moving roller.

11. The mobile robot of claim 10, further comprising:
a control unit configured to detect a state that the mobile robot is not able to move; and
a linear motor coupled to the caterpillar,
wherein the linear motor is caused to remove pins from the belt assembly when the control unit detects a state that the mobile robot is not able to move.

12. The mobile robot of claim 10, further comprising:
a control unit configured to detect a state that the mobile robot is not able to move; and
a linear motor coupled to the caterpillar,
wherein the linear motor is caused to remove the one or more main moving roller or the one or more subsidiary moving rollers when the control unit detects a state that the mobile robot is not able to move.
